(19) United States
(12) Patent Application Publication
(10) Pub. No.: US 2005/0066040 A1
(43) Pub. Date: Mar. 24, 2005

(54) Method and apparatus to facilitate conducting an internet protocol session using previous session parameter(s)

(75) Inventors: Michael Borella, Naperville, IL (US); Arun Alex, Bartlett, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Incorporated

(21) Appl. No.: 10/664,673

(22) Filed: Sep. 18, 2003

(51) Int. Cl. G06F 15/16

(52) U.S. Cl. 709/228; 709/238

(57) ABSTRACT

Under at least some operating circumstances, when a temporary session parameter (such as, for example, a temporarily assigned Internet protocol address or a negotiated point-to-point protocol session parameter) is used during a first Internet protocol session for a given node, and that node initiates a new (or what appears to be a new) session within a limited period of time, that temporary session parameter is again used to facilitate the new session.

### RELATED APPLICATIONS

This application claims the benefit of Provisional Application Ser. No. ______, entitled Firm Allocation of IP Addresses on a Wireless Access Gateway and filed on Jul. 3, 2003, which is incorporated herein by this reference.

### TECHNICAL FIELD

This invention relates generally to Internet protocol sessions and more particularly to temporarily designated session parameters.

### BACKGROUND

The prior art supports use of the well-known Internet protocol to establish and conduct a communication session. This includes supporting Internet protocol sessions for wireless nodes (such as but not limited to a laptop computer, cell phone, or personal digital assistant that is configured with a wireless communication capability). Frequently such a wireless node is assigned a temporary address to be used during a given session. Such a temporary address will often be immediately unassigned and returned to a pool of available temporary addresses upon the conclusion of such a session.

Unfortunately, a given wireless session can appear to conclude when in fact the wireless node has further communications to conduct. The imperfections of wireless communications themselves contribute significantly in this regard. For example, an Internet protocol session can appear to conclude due to signal fading, signal obstruction, interference, and many other phenomena and causes. Although such causes are typically short lived (lasting, in many cases, only a few seconds) the wireless node will nevertheless usually be forced to reinitiate a new Internet protocol session to complete its communications needs.

Under some circumstances such reinitiation may not represent a particularly onerous circumstance. For example, reinitiation may be accomplished relatively quickly so that the user does not experience an objectionably long interruption. There are circumstances, however, when such a process introduces considerably greater difficulties. As one illustration amongst many, the wireless node may be assigned a new and different temporary address for the new session. This new temporary address may be a source of confusion to a third party with whom the wireless node was previously communicating. This, in turn, can delay or even frustrate completely an interrupted file download and require the wireless node to begin the previously interrupted process anew. As another example, the interrupted session may have been using one or more other session parameters that were the result of extended negotiation as between the wireless node and one or more other access points or components of the communication stream or process. Reinitation of a new session may require that these parameters be renegotiated anew and thereby require a commensurate expenditure of time and/or other resources.

### BRIEF DESCRIPTION OF THE DRAWINGS

The above needs are at least partially met through provision of the method and apparatus to facilitate conducting an internet protocol session using at least one previous session parameter described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a flow diagram as configured in accordance with an embodiment of the invention;

FIG. 5 comprises a flow diagram as configured in accordance with an embodiment of the invention;

FIG. 6 comprises a flow diagram as configured in accordance with another embodiment of the invention; and

FIG. 7 comprises a flow diagram as configured in accordance with yet another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, an Internet protocol session facilitation apparatus comprises an Internet protocol session facilitator and a memory having at least one previous temporary Internet protocol session parameter as corresponds to a recently concluded session temporarily stored for no more than a limited time therein. For example, when a first Internet protocol session with a given node using at least one temporary session parameter concludes (or at least appears to conclude), that temporary session parameter is stored in the memory. When that node then seeks to initiate a subsequent Internet protocol session within a predetermined period of time as corresponds to the conclusion of the first Internet protocol session, the facilitator retrieves that parameter from the memory and uses that parameter to facilitate the second Internet protocol session.

In a preferred embodiment, that stored information can include a temporarily assigned Internet protocol address as was previously assigned to the node. In this case, upon concluding the first Internet protocol session, and while retaining this parameter information in the memory, the temporarily assigned Internet protocol address is not returned to a pool of available addresses. In other embodiments, the stored information can comprise (in addition to the above or in lieu thereof) a point-to-point protocol session parameter (or parameters), a domain name system session parameter, an Internet protocol compression session parameter, and so forth.

Depending upon the embodiment and the needs of a given application, the parameter information can be stored for a fixed period of time or for a dynamically alterable period of time. As to the latter, the duration can be determined as a function, for example, of a time of day (or a day of the week) when the first Internet protocol session concludes. As another example, the duration can be determined as a function of a particular priority as may pertain to the wireless node. As yet another example, the duration can be determined as a function of the number of Internet protocol session resources that may be presently available (for example, when a particularly large number of temporarily assignable Internet protocol addresses are available, the storage duration can be allowed to be longer than when there are only a few addresses presently available for assignment).

So configured, a hang-time duration permits a wireless node to reinitiate an interrupted Internet protocol session with the benefit of one or more previously utilized, established, or negotiated session parameters. This, in turn, can facilitate more efficient provisioning of a wireless node, a more easily facilitated optimized session configuration, and/or a less confusing session paradigm for other nodes with which the wireless node was previously communicating. Notwithstanding these benefits, these various embodiments do not unduly compromise the temporarily assignable and/or negotiable resources of a given system. These embodiments will also accommodate a wide degree of flexibility with respect to the details that characterize a particular implementation.

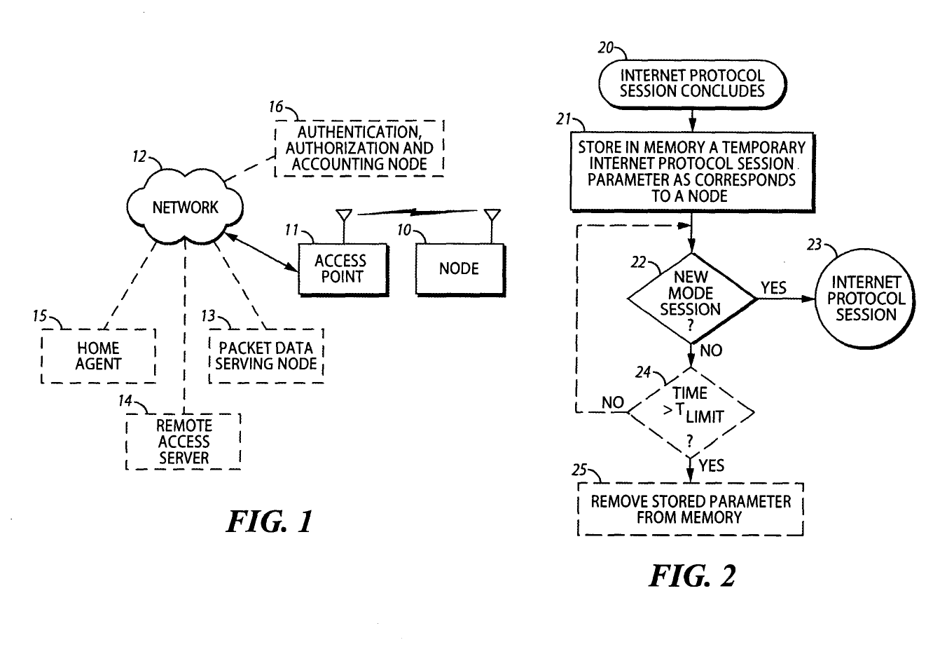

Referring now to FIG. 1, as is well understood in the art, a wireless node 10 will communicate via a compatible access point 11 to gain access to a network 12 such as, for example, the Internet (or other extranet), an intranet (such as an enterprise-scale local area network, or the like. Various wireless mediums and protocols (such as the CDMA2000 architecture) are known in the art to support such a link and doubtless additional options will be proposed in the future. As these various platforms and methodologies are well understood in the art, and as these embodiments are generally compatible with any or all of these options such that no one particular platform or method is overly essential to such embodiments, no further detailed description will be provided here for the sake of brevity and the preservation of focus.

Regardless of what overlay methodology may be used between the node 10 and the access point 11, communications by the node 10 via the network 12 are themselves conducted using the Internet protocol as is otherwise well understood in the art. Such an Internet protocol session can potentially be facilitated by one or more various other nodes, including the access point 11 itself, a packet data serving node 13, a remote access server 14, a home agent 15 for the wireless node 10, an authentication, authorization, and accounting node 16, or a gateway general packet radio service support node to name a few. (It will be understood and appreciated that these examples are illustrative only and that other kinds and category of nodes can and likely will play a relevant part from time to time with respect to establishing and/or maintaining a given Internet protocol session.)

In general, there are two kinds of Internet protocol calls; mobile IP calls and simple IP calls. A mobile IP call typically permits an IP address to be assigned by a home network to a given node such that the node can retain and use that assigned address as it roams from one access point to another. A simple IP call typically relies upon a more temporarily assigned IP address as assigned by a visited system. Such temporarily assigned IP address may be assigned for the duration of a given node's stay within a given visited system, or may be assigned on an as-needed basis to support only a given session. These embodiments can be useful in all of the above approaches but are particularly beneficial when used with session-based assignments.

Other details regarding these potentially applicable platforms are provided below where pertinent. In general, one or more of these components (or another node or nodes within the system) serve as an Internet protocol session facilitator that can both store one or more temporary Internet protocol session parameters upon the conclusion of a session and then recall that stored information to aid in facilitating a second Internet protocol session provided that no more than a predetermined amount of time passes between the conclusion of the first session and the initiation of the second session. In effect, this facilitator provides a hang-time during which a previous determined, negotiated, or assigned temporary Internet protocol session parameter (or parameters) can be used to facilitate a subsequent session. For example, a previously assigned temporary Internet protocol address (such as a temporarily assigned simple Internet protocol address) can be retained and reused during a subsequent session when the subsequent session is initiated within the specified hang-time.

Referring now to FIG. 2, pursuant to a preferred approach, when an Internet protocol session for a given node concludes 20, at least one temporary Internet protocol session parameter as corresponds to that node is stored 21. Any number of temporary Internet protocol session parameters (alone or in combination) can be stored in this fashion, including but not limited to a temporary Internet protocol address (such as a simple Internet protocol address or a mobile Internet protocol address) as was assigned to the node for the just concluded Internet protocol session, information that corresponds to one or more point-to-point protocol session parameters as were negotiated by the node during the just concluded Internet protocol session, a domain name system session parameter, and an Internet protocol session compression parameter, to name a few. Upon detecting 22 initiation of a new session for this same node, the process 20 can then facilitate that Internet protocol session 23 using this stored information as described below in more detail.

In a preferred embodiment, the subsequent Internet protocol session must be initiated within a predetermined period of time following termination of the previous Internet protocol session. Otherwise, the temporary Internet protocol session parameter will no longer be retained in memory. There are various ways to implement such a requirement. Pursuant to one approach, the process 20 can optionally determine 24 whether and when a predetermined period of time Tₗᵢₘᵢₜ expires. When this duration of time has passed, the process 20 can then optionally remove 25 the stored parameter or parameters from the memory. Pursuant to another approach, these memory contents don't necessary need to be removed but can be flagged or otherwise identified in some appropriate fashion to indicate that the corresponding information is no longer current and/or is no longer to be used.

The duration of time can be fixed or dynamically alterable as best meets the needs of a given application. For example, the duration of time can be fixed as a specific amount of time, such as 0.5 seconds, 1.0 seconds, 3.0 seconds, 5.0 seconds, 10.0 seconds, 30.0 seconds, and so forth.

As another approach, the duration of time can be selected from amongst a range of candidate periods of time. For example, 1.0 seconds, 5.0 seconds, and 10.0 seconds can all be available candidate periods of time and one of these predetermined specific periods of time can be selected for use during implementation of the process 20. The selection criteria can be specific to the node receiving communication services (for example, the user of the node may be paying for a particular level of quality of service that would correlate to use of a longer period of time) and/or non-specific to the node (for example, shorter durations might be used during a time of day when communication traffic and the need for assignable temporary Internet protocol session addresses was known to be predictably high).

As yet another approach the duration of time can be determined via even more dynamic means. To illustrate, the duration of time can be flexibly selected from within a permitted range of boundary values as a function of, for example, when the initial Internet protocol session concludes (for example, shorter values may be used during a given time of day or during a given day of the week). As another illustration, the duration of time can be flexibly assigned as a function of the number of corresponding available Internet protocol session resources. As one simple example, if a system has thirty assignable temporary addresses, then the duration of time to be used in a given setting could be one second multiplied by the number of presently available assignable temporary addresses. With twenty-seven available resources, a corresponding twenty-seven seconds could be used as the hang-time following a concluded Internet protocol session. When only two such resources are available, however, then only a corresponding two second window would be used for the resultant hang-time when using this approach.

It would also be possible to form various combinations and permutations of the above illustrative approaches. And, of course, there will no doubt be other useful and beneficial approaches to arriving at a relevant and useful duration of time to be used in a given context and at a given time to permit a hang-time that will aid in serving the identified needs while also avoiding unduly compromising the overall operation of the network.

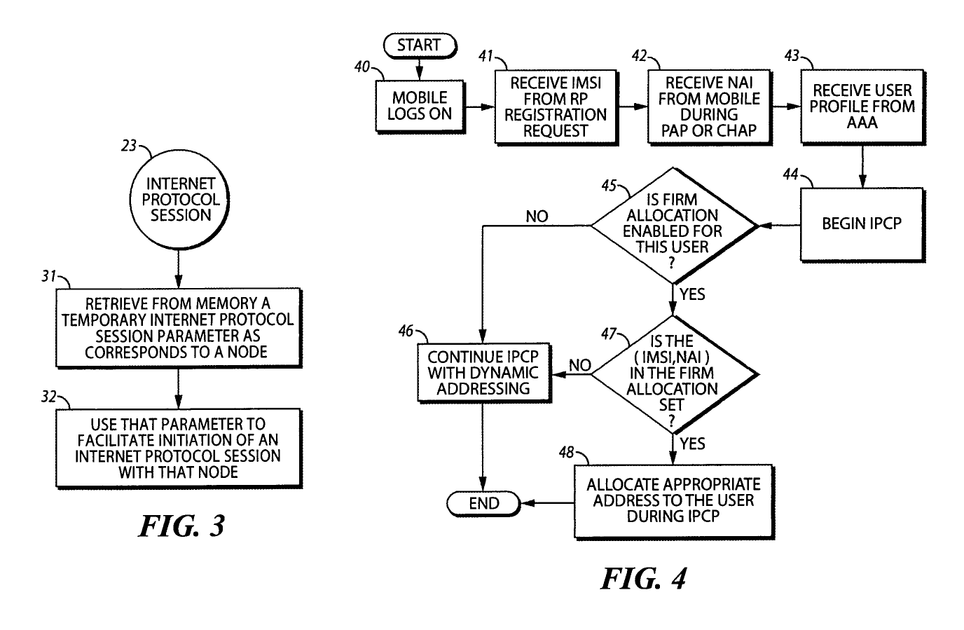

Referring now to FIG. 3, when a wireless node initiates a subsequent Internet protocol session 23 within the requisite period of time, the facilitator can retrieve 31 from memory the stored temporary Internet protocol session parameter(s) as correspond to that node and use 32 that information to facilitate initiation of a new Internet protocol session. For example, when the parameter comprises a temporarily assigned Internet protocol session address as was assigned to facilitate the earlier session, that same Internet protocol session address can again be used during this subsequent session. (This presumes again, of course, that this particular address was not only identified in memory as described but also that this address was not returned to the pool of available assignable resources to thereby ensure its current availability. Once the predetermined period of time expires as noted above, the address can then be returned to the pool for subsequent assignment to other nodes as may be needed.)

It will be clear to those skilled in the art that the particular use 32 that will be made of the stored temporary parameter will derive in substantial part from the kind of parameter that has been stored. An address will be used as an address. A compression setting will be used as a compression setting. A negotiated point-to-point protocol session parameter will be used when re-establishing and characterizing or negotiating a new point-to-point protocol session, and so forth.

So configured, one can conduct a first Internet protocol session with a node using at least one temporary session parameter and then store information that corresponds to that parameter upon concluding that first Internet protocol session. When that node then seeks to initiate a second Internet protocol session within a predetermined period of time as corresponds to concluding the first Internet protocol session, one can retrieve from memory that temporary Internet protocol session parameter or parameters and use it or them to facilitate the second Internet protocol session. This provides both expediency and continuity that present practices lack when, for example, a given Internet protocol session is interrupted (and seemingly concluded) by phenomena such as a temporarily troubled wireless communication path. In particular, for the duration of the predetermined period of time a temporarily assigned address is essentially firmly allocated to a given node notwithstanding the inherent temporary nature of this assignment.

As alluded to earlier, these embodiments can be practiced in a variety of ways by a variety of platforms. To illustrate this a number of more specific examples will now be presented.

### EXAMPLE 1

Referring now to FIG. 4, a packet data serving node can serve as an implementing platform. Pursuant to this example, the packet data serving node maintains a pool of Internet protocol addresses that can be temporarily assigned to support the communication needs of various wireless nodes. A given wireless node, comprising a mobile platform in this example, can log on 40 via an access point and provides 41 it's international mobile subscriber identity (IMSI) as part of an A11 radio packet (RP) registration request (as per, for example, IS2001).

The mobile then provides 42 its native address identifier (NAI) using, for example, password authentication procedure (PAP) or challenge-handshake authentication protocol (CHAP). This information facilitates requesting and then receiving 43 a corresponding user profile for the mobile node from the appropriate authentication, authorization, and accounting node such that Internet protocol control protocol (IPCP) can be begun 44. The packet data serving node would then determine 45 if firm allocation has been enabled for this particular mobile user. If not (perhaps because the mobile is specifically or categorically denied such service) then the packet data serving node continues 46 with normal and ordinary dynamic assignment of a temporary address as selected from amongst a pool of available addresses.

When firm allocation as per the above has been enabled, however, the packet data serving node next determines 47 whether a particular temporary address is in fact presently set for this particular node (for example the IMSI and/or NAI of the node can be used to correlate the node to a specific previously used and stored address). When the requisite time has expired, the process can simply continue with ordinary dynamic addressing 46 as per prior practice. When the requisite time has not expired, however, the packet data serving node can allocate 48 the stored/withheld address for use by the mobile node during this particular session, thereby providing address continuity as between this second session and the earlier preceding session.

### EXAMPLE 2

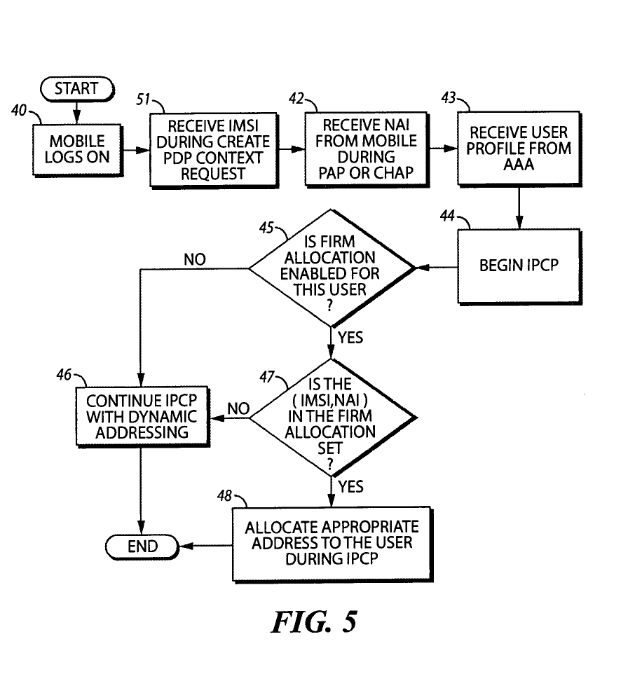

Referring now to FIG. 5, a gateway general packet radio service support node can also serve as a facilitating platform.

Much of this example parallels the process described above in example 1 and hence will not be repeated here. In this example, however, the gateway general packet radio service support node will use the firm allocation process in conjunction with allocating a pool of temporary Internet protocol session addresses. So configured, the gateway general packet radio service support node will receive 51 the mobile's IMSI during a create packet data protocol (PDP) context request following which the mobile's NAI may be received during a PAP or CHAP exchange, if the mobile and gateway general packet radio service support node use point-to-point protocol. In all other respects the gateway general packet radio service support node can then effect the same process as was related above in example 1 with respect to the packet data serving node.

### EXAMPLE 3

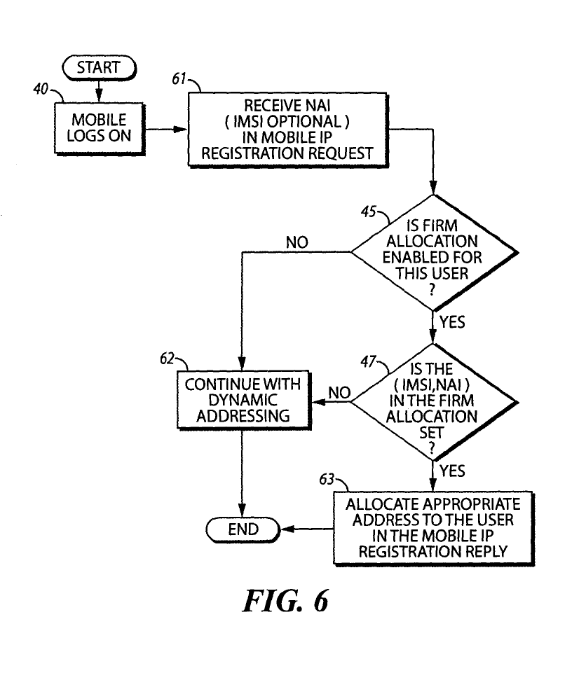

With reference to FIG. 6, a home agent can also be used to facilitate such processes. For example, the home agent may have a pool of Internet protocol addresses that can be temporarily assigned to support the communication needs of various mobile nodes. Such a home agent can use firm allocation as generally described above to influence such allocation. As illustrated a substantially equivalent process as described above for earlier examples applies here as well. The home agent receives the mobile's NAI (or, optionally, its IMSI as well) pursuant to an Internet protocol registration request 61 and then determines 45 whether firm allocation has been enabled for this mobile. When not enabled, the home agent continues 62 with ordinary dynamic assignment of a temporary address from its pool of available addresses. When such allocation has been enabled, however, the home agent can determine 47 whether a previously used address is in fact still firmly allocated and, when true, that address can remain allocated 63 via a mobile Internet protocol registration reply.

### EXAMPLE 4

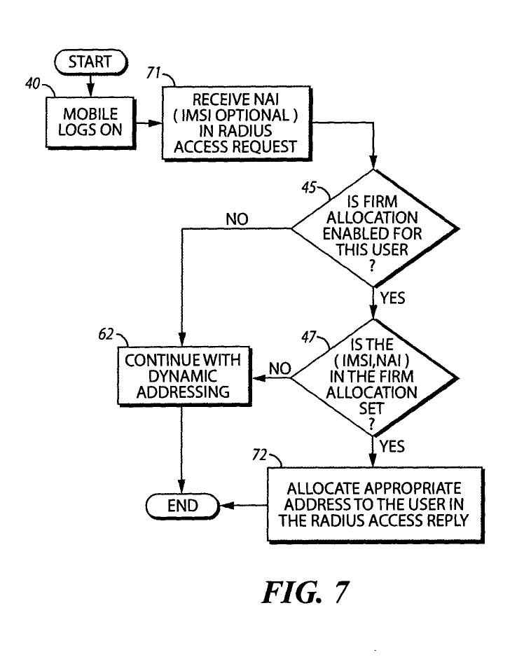

Referring now to FIG. 7, an authentication, authorization, and accounting node can also be utilized to realize these teachings. The authentication, authorization, and accounting node will receive 71 the NAI (or, optionally, the IMSI) of the mobile node via a RADIUS access request and again determine 45 whether firm allocation has been enabled for this mobile. When not true, the authentication, authorization, and accounting node utilizes 62 ordinary dynamic address allocation. When true, however, the authentication, authorization, and accounting node determines 47 whether an existing address allocation remains firm and, if true, allocates 72 that address in a RADIUS access reply to again preserve address continuity as between the present session and the previous recent session.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, a given implementing platform may store in memory the home agent's Internet protocol address for a given mobile node so that the same home agent can be used if that same node reconnects with the specified timeout window.

As another example, a foreign agent control node can also serve to facilitate these teachings. Though a foreign agent control node will not ordinarily allocate Internet protocol addresses, this node does direct incoming calls to a particular packet data serving node and therefore can benefit by remembering which packet data serving node to use when facilitating a reconnected call. The foreign agent control node will receive the mobile's user profile when the mobile logs on to the network. From this profile the foreign agent control node can determine whether or not the mobile is provisioned for firm allocation (when firm allocation is not indicated in the user profile but is set at the packet data serving node only, the later will preferably inform the foreign agent control node of this status during call setup). When a session provisioned with firm allocation concludes, the foreign agent control node can temporarily store the firm allocation time along with the serving packet data serving node's Internet protocol address, for the specified amount of time. When a call from the same mobile re-originates before the timer expires, the foreign agent control node can send this call to the specified packet data serving node.

As yet another example, a serving general packet radio service support node (commonly referred to as an SGSN) can also benefit from these teachings. Though an SGSN will not ordinarily allocate Internet protocol addresses, this node does direct incoming calls to a particular gateway general packet radio service support node and therefore can benefit by remembering which gateway general packet radio service support node to use when facilitating a reconnected call. The SGSN will receive the mobile's user profile from a corresponding home location register when the mobile logs on to the network. From this profile the SGSN can determine whether or not the mobile is provisioned for firm allocation (when firm allocation is not indicated in the user profile but is set at the gateway general packet radio service support node only, the later will preferably inform the SGSN of this status during call setup). When a session provisioned with firm allocation concludes, the SGSN can temporarily store the firm allocation time along with the gateway general packet radio service support node's Internet protocol address, for the specified amount of time. When a call from the same mobile re-originates before the timer expires, the SGSN can send this call to the specified gateway general packet radio service support node.

As yet one more example, these teachings can be employed to facilitate rapid point-to-point protocol session establishment. With such firm allocation enabled, a packet data serving node (or other appropriate platform, such as a gateway general packet radio service support node) can save a negotiated set of point-to-point protocol parameters (such as, but not limited to, a link control protocol parameter, an Internet protocol control protocol parameter, a compression control parameter (CCP) and the like) along with the Internet protocol address that was assigned to the mobile that same session. When the mobile then re-registers within the appropriate time frame as specified above, the packet data serving node (or other appropriate platform) can offer only point-to-point protocol parameters that the mobile had already recently accepted. This can reduce the number of negotiation messages that are normally sent (by upwards of one half) and thereby enable a faster call setup time.

And as yet one more example, such a temporary Internet protocol session parameter (or parameters) for a given node can be retrieved from memory in response to an event other than reinitiation (or initiation) of a call within a particular period of time by that node itself For example, when a second, different node seeks to communicate with that first node within a predetermined period of time following termination of the previous first node Internet protocol session, one or more of those same stored parameters can be retrieved from memory and used to support the newly requested Internet protocol session.

1. A method to facilitate conducting an Internet protocol session comprising:
retrieving from memory at least one temporary Internet protocol session parameter as corresponds to a node;
using that at least one temporary Internet protocol session parameter to facilitate initiation of an Internet protocol session with the node.

2. The method of claim 1 wherein retrieving from memory at least one temporary Internet protocol session parameter as corresponds to a node comprises retrieving from memory a temporarily assigned Internet protocol address as was recently previously assigned to the node.

3. The method of claim 2 wherein retrieving from memory a temporarily assigned Internet protocol address as was recently previously assigned to the node comprises retrieving from memory a temporarily assigned Internet protocol address as was recently previously assigned to the node and not then yet subsequently returned to a pool of available temporary Internet protocol addresses.

4. The method of claim 1 wherein retrieving from memory at least one temporary Internet protocol session parameter as corresponds to a node comprises retrieving from memory at least one point-to-point protocol session parameter.

5. The method of claim 1 wherein retrieving from memory at least one temporary Internet protocol session parameter as corresponds to a node comprises retrieving from memory at least one domain name system session parameter.

6. The method of claim 1 wherein retrieving from memory at least one temporary Internet protocol session parameter as corresponds to a node comprises retrieving from memory at least one Internet protocol session compression parameter.

7. The method of claim 4 wherein retrieving from memory at least one point-to-point protocol session parameter comprises retrieving from memory at least one point-to-point protocol session parameter as corresponds to a recent point-to-point protocol session as was conducted with the node.

8. The method of claim 4 wherein retrieving from memory at least one point-to-point protocol session parameter comprises retrieving from memory a plurality of point-to-point protocol session parameters.

9. The method of claim 4 wherein using that at least one temporary Internet protocol session parameter to facilitate initiation of an Internet protocol session with the node comprises using the at least one point-to-point protocol session parameter to negotiate a new point-to-point protocol session with the node.

10. The method of claim 1 wherein retrieving from memory at least one temporary Internet protocol session parameter as corresponds to a node comprises only retrieving from memory at least one temporary Internet protocol session parameter as corresponds to a node when the node seeks to facilitate the Internet protocol session within a predetermined period of time following termination of a previous Internet protocol session.

11. The method of claim 1 wherein retrieving from memory at least one temporary Internet protocol session parameter as corresponds to a first node comprises retrieving from memory at least one temporary Internet protocol session parameter as corresponds to a node when a second node seeks to communicate with the first node within a predetermined period of time following termination of a previous Internet protocol session.

12. The method of claim 1 wherein retrieving from memory at least one temporary Internet protocol session parameter as corresponds to a node comprises retrieving from memory at a packet data serving node at least one temporary Internet protocol session parameter as corresponds to a node.

13. The method of claim 1 wherein retrieving from memory at least one temporary Internet protocol session parameter as corresponds to a node comprises retrieving from memory at a remote access server at least one temporary Internet protocol session parameter as corresponds to a node.

14. The method of claim 1 wherein retrieving from memory at least one temporary Internet protocol session parameter as corresponds to a node comprises retrieving from memory at a home agent at least one temporary Internet protocol session parameter as corresponds to a node.

15. The method of claim 1 wherein retrieving from memory at least one temporary Internet protocol session parameter as corresponds to a node comprises retrieving from memory at a gateway general packet radio service support node at least one temporary Internet protocol session parameter as corresponds to a node.

16. A method to facilitate conducting an Internet protocol session comprising:
conducting a first Internet protocol session with a node using at least one temporary session parameter;
upon concluding the first Internet protocol session, storing information that corresponds to the at least one temporary Internet protocol session parameter;
when the node seeks to initiate a second Internet protocol session within a predetermined period of time as corresponds to concluding the first Internet protocol session:
retrieving from memory the at least one temporary Internet protocol session parameter;
using that at least one temporary Internet protocol session parameter to facilitate the second Internet protocol session.

17. The method of claim 16 wherein storing information that corresponds to the at least one temporary Internet protocol session parameter comprises storing information that corresponds to a temporary Internet protocol address as was assigned to the node for the first Internet protocol session.

18. The method of claim 16 wherein storing information that corresponds to the at least one temporary Internet protocol session parameter comprises storing information that corresponds to point-to-point protocol session parameters as were negotiated by the node for the first Internet protocol session.

19. The method of claim 16 wherein retrieving from memory at least one temporary Internet protocol session parameter as corresponds to a node comprises retrieving from memory at least one domain name system session parameter.

20. The method of claim 16 wherein retrieving from memory at least one temporary Internet protocol session parameter as corresponds to a node comprises retrieving from memory at least one Internet protocol session compression parameter.

21. The method of claim 16 wherein the predetermined period of time comprises a substantially fixed predetermined period of time.

22. The method of claim 21 wherein the substantially fixed predetermined period of time is selected from within a range of candidate periods of time.

23. The method of claim 16 wherein the predetermined period of time comprises a dynamically determined period of time.

24. The method of claim 23 and further comprising:
determining the dynamically determined period of time as a function, at least in part, of a time when the first Internet protocol session concludes.

25. The method of claim 24 wherein determining the dynamically determined period of time as a function, at least in part, of a time when the first Internet protocol session concludes comprises determining the dynamically determined period of time as a function, at least in part, of a time of day when the first Internet protocol session concludes.

26. The method of claim 24 wherein determining the dynamically determined period of time as a function, at least in part, of a time when the first Internet protocol session concludes comprises determining the dynamically determined period of time as a function, at least in part, of a day when the first Internet protocol session concludes.

27. The method of claim 23 and further comprising:
determining the dynamically determined period of time as a function, at least in part, of a prioritization as pertains to the node.

28. The method of claim 23 and further comprising:
determining the dynamically determined period of time as a function, at least in part, of available Internet protocol session resources.

29. The method of claim 28 wherein determining the dynamically determined period of time as a function, at least in part, of available Internet protocol session resources comprises determining the dynamically determined period of time as a function, at least in part, of available temporary Internet protocol addresses.

30. An Internet protocol session facilitation apparatus comprising:
an Internet protocol session facilitator;
a memory having at least one previous temporary Internet protocol session parameter as corresponds to a recently concluded session temporarily stored for no more than a limited time therein as corresponds to a concluded Internet protocol session.

31. The Internet protocol session facilitation apparatus of claim 30 wherein the Internet protocol session facilitator comprises a packet data serving node.

32. The Internet protocol session facilitation apparatus of claim 30 wherein the Internet protocol session facilitator comprises a remote access server.

33. The Internet protocol session facilitation apparatus of claim 30 wherein the Internet protocol session facilitator comprises a home agent.

34. The Internet protocol session facilitation apparatus of claim 30 wherein the Internet protocol session facilitator comprises a gateway general packet radio service support node.

35. The Internet protocol session facilitation apparatus of claim 30 wherein the Internet protocol session facilitator comprises an authentication, authorization, and accounting node.

36. The Internet protocol session facilitation apparatus of claim 30 wherein the Internet protocol session facilitator comprises hang-time means for using the at least one previous temporary Internet protocol session parameter to facilitate a new Internet protocol session for a common node.

37. The Internet protocol session facilitation apparatus of claim 36 wherein the hang-time means only uses the at least one previous temporary Internet protocol session parameter to facilitate a new Internet protocol session when the common node seeks to initiate the new Internet protocol session within a predetermined period of time of when a pervious Internet protocol session concluded.

38. The Internet protocol session facilitation apparatus of claim 30 wherein the at least one previous temporary Internet protocol session parameter comprises a temporary Internet protocol address.

39. The Internet protocol session facilitation apparatus of claim 38 wherein the temporary Internet protocol address comprises a simple Internet protocol address.

40. The Internet protocol session facilitation apparatus of claim 30 wherein the at least one previous temporary Internet protocol session parameter comprises at least one point-to-point protocol negotiated session parameter.

41. The Internet protocol session facilitation apparatus of claim 30 wherein the at least one previous temporary Internet protocol session parameter comprises:
a temporary Internet protocol address; and
at least one point-to-point protocol negotiated session parameter.
